(19) United States
(12) Patent Application Publication
(10) Pub. No.: US 2022/0373752 A1
(43) Pub. Date: Nov. 24, 2022

(54) TIGHT BUFFERED OPTICAL FIBERS THAT RESIST SHRINKAGE

(71) Applicant: Superior Essex Internation LP, (US)

(72) Inventor: Christopher Robert Evans, Kennesaw, GA (US)

(73) Assignee: Superior Essex International LP, Altanta, GA (US)

(21) Appl. No.: 17/081,603

(22) Filed: Oct. 27, 2020

(51) Int. Cl. G02B 6/44; G02B 6/02

(52) U.S. Cl. CPC G02B 6/443; G02B 6/02395

(57) ABSTRACT

A cable may include an optical fiber and a tight buffer layer formed around the optical fiber. Additionally, a conductive toner wire may be coupled to the tight buffer layer in order to reduce shrinkage of the tight buffer layer due to low temperatures. A maximum distance between the optical fiber and the toner wire may be 1.0 mm.

### TECHNICAL FIELD

Embodiments of the disclosure relate generally to tight buffered optical fibers and, more particularly, to tight buffered optical fibers and associated cables that exhibit improved cold temperature performance and that resist buffer layer shrinkage.

### BACKGROUND

Optical fiber cables are utilized in a wide variety of applications. In many instances, the cables include tight buffered optical fibers. A tight buffered optical fiber typically includes an optical waveguide fiber, one or more protective coatings (e.g., a primary coating, a secondary coating, etc.) surrounding an outer surface of the fiber, and a polymeric buffer layer formed to surround the optical fiber and its protective coating(s). The buffer layer is formed in intimate contact with the protective coating(s). Many conventional materials utilized to form buffer layers may be subject to expansion and contraction as a result of environmental temperature and/or humidity variations. Buffer layer expansion and/or shrinkage (e.g., cold temperature shrinkage, etc.) can cause undesirable tensile and compressive forces to be transferred to the optical fibers, thereby resulting in degradation of the optical fiber performance. Accordingly, there is an opportunity for improved tight buffered optical fibers and associated cables that exhibit improved cold temperature performance and/or that resist buffer layer shrinkage. In particular, there is an opportunity for improved tight buffered optical fibers having one or more conductive strength and/or toner wires coupled to the buffer layer.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1-3 are cross-sectional views of example optical fiber cables that include one or more tight buffer units that have at least one conductive wire coupled to a tight buffer layer, according to illustrative embodiments of the disclosure.

FIGS. 4A-4E are cross-sectional views of example tight buffer units that include at least one conductive wire coupled to a tight buffer layer, according to illustrative embodiments of the disclosure.

### DETAILED DESCRIPTION

Various embodiments of the present disclosure are directed to tight buffered optical fibers and cables including tight buffered optical fibers. An optical fiber, such as an optical fiber including a core, a cladding, and one or more protective coatings, may be surrounded by a tight buffer layer along a longitudinal direction of the fiber. Additionally, according to an aspect of the disclosure, a conductive wire may be coupled to the tight buffer layer. For example, a conductive toner wire may be coupled to the tight buffer layer. The coupled wire may have a low coefficient of thermal expansion. As a result of being coupled to the tight buffer layer, the conductive wire may facilitate reduced shrinkage of the tight buffer layer, thereby improving cold temperature performance. Similarly, the conductive wire may facilitate reduced expansion of the tight buffer layer.

In certain embodiments, the conductive wire may optionally be utilized as a toner wire. For example, the wire may be utilized to carry a toner signal that may be utilized to locate a buried or other optical fiber cable. Regardless of whether the conductive wire is utilized as a toner wire, the conductive wire may be referred to herein as a toner wire or as a conductive toner wire. Additionally, in certain embodiments, the toner wire may be tightly or intimately coupled to a buffer layer. For example, a maximum distance between the optical fiber and the conductive toner wire may be approximately 1.0 mm or less. In certain embodiments, a maximum distance between the optical fiber and the toner wire may be approximately equal to a thickness of a tight buffer layer formed around the optical fiber.

A wide variety of suitable materials may be utilized to form a conductive toner wire. In certain embodiments, a toner wire may be formed from any suitable electrically conductive material, such as copper, aluminum, silver, annealed copper, gold, a conductive alloy, etc. Additionally, the conductive material incorporated into a toner wire may be formed as either a solid conductor or, alternatively, as a plurality of conductive strands that are twisted together. In certain embodiments, the toner wire may be formed without insulation. In other embodiments, the toner wire may include polymeric insulation formed around a conductor. Additionally, the toner wire may be formed with any suitable diameter, gauge, and/or other dimensions. In certain embodiments, the toner wire may have an outer diameter of approximately 1.0 mm or less.

A wide variety of suitable methods, techniques, and/or configurations may be utilized to couple a toner wire to a tight buffered optical fiber. In certain embodiments, the toner wire may be pressed into the polymeric material utilized to form a tight buffer layer, for example, prior to the tight buffer layer being completely cooled. In other embodiments, the toner wire may be positioned into a longitudinally extending groove or channel formed in the tight buffer layer. In other embodiments, the toner wire may be adhered to the tight buffer layer. In other embodiments, polymeric material may be extruded around both the optical fiber and the toner wire. For example, the tight buffer layer and insulation formed around a toner wire conductor may be co-extruded. As desired, the tight buffered optical fiber and the toner wire may be arranged in a figure eight configuration. In yet other embodiments, the toner wire and the tight buffer layer may be helically twisted together. In yet other embodiments, the toner wire may be formed around the tight buffer layer. As desired in any of these configurations, an optional jacket layer may be formed around both the toner wire and the tight buffer layer.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

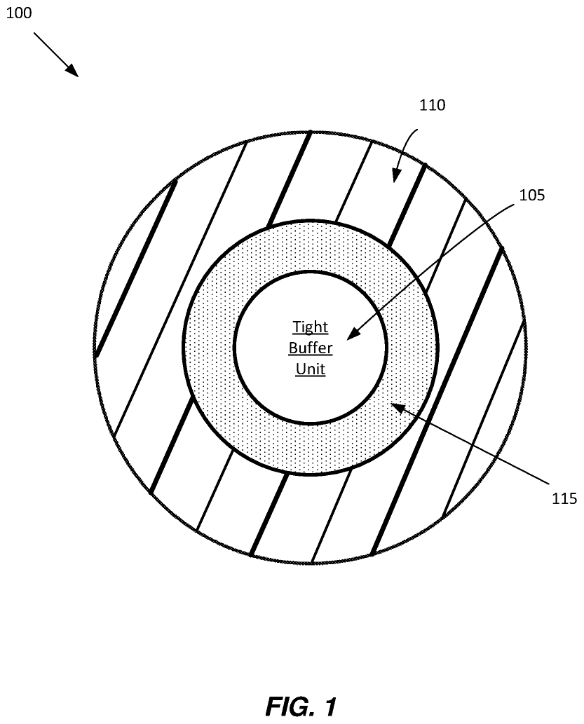

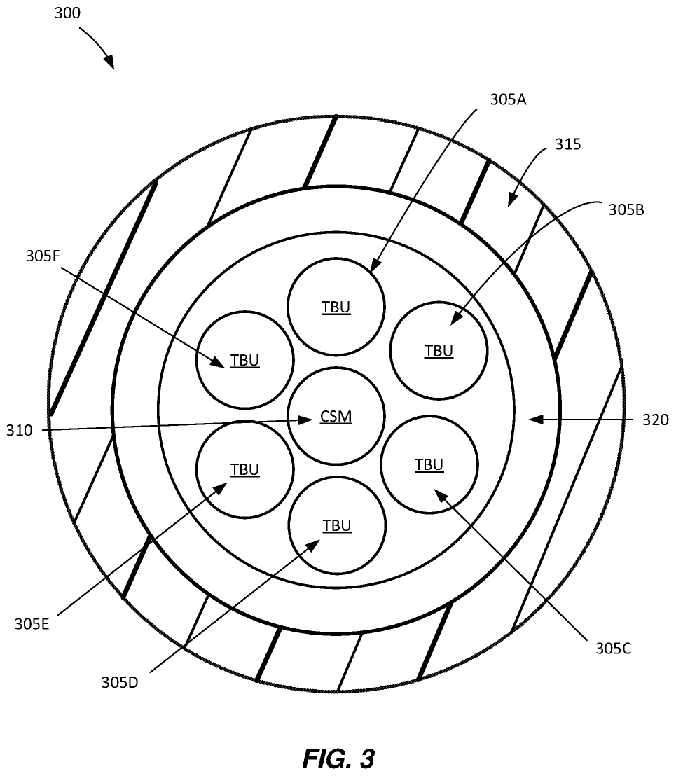

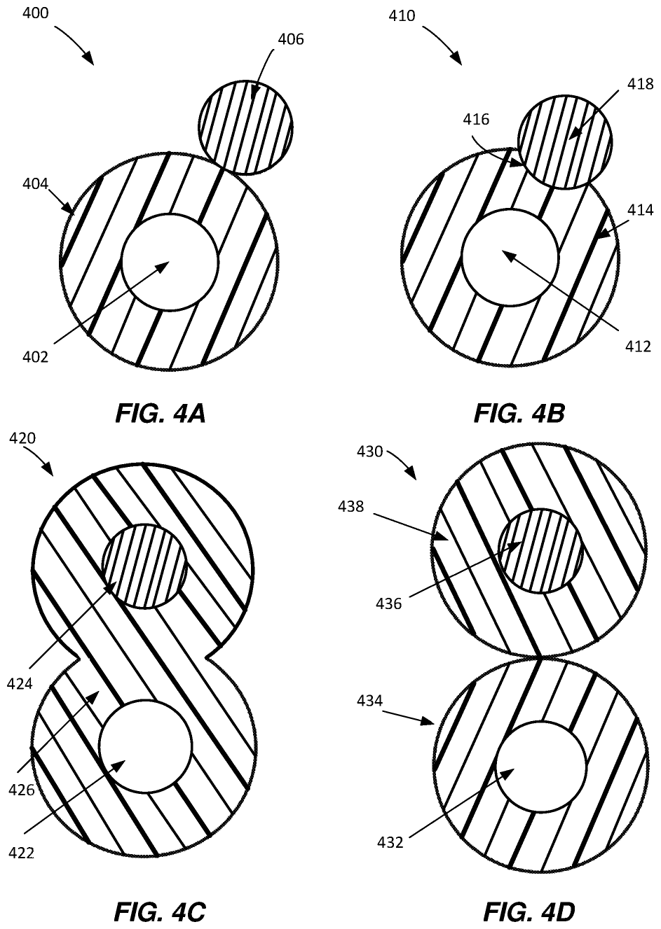

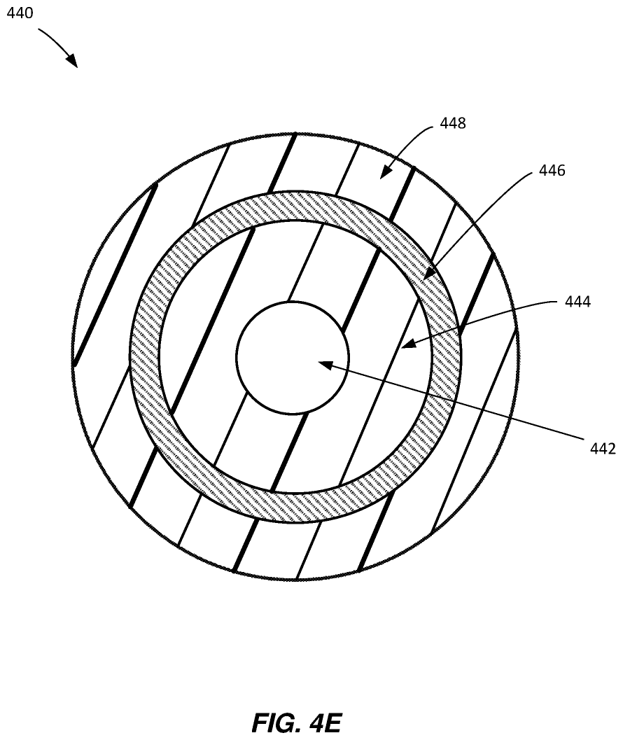

For purposes of this disclosure, the term “tight buffer unit” or “TBU” may refer to an optical fiber component that includes a tight buffer layer formed around an optical fiber and any desired number of protective coatings. Additionally, the tight buffer unit may include a conductive wire or conductive toner wire coupled to the tight buffer layer. The coupling between the toner wire and the tight buffer unit may improve the cold temperature performance of the tight buffer layer and/or limit shrinkage of the tight buffer layer. In certain embodiments, a maximum distance between the optical fiber positioned within the tight buffer layer and the toner wire may be approximately 1.0 mm or less. A few non-limiting example constructions of tight buffer units are described in greater detail below with reference to FIGS. 4A-4E. Any of these example constructions may be incorporated into an optical fiber cable, hybrid cable, or other cable that includes one or more tight buffered optical fibers. For example, any of the example tight buffer units illustrated in FIGS. 4A-4E may be incorporated into any of the example cable constructions illustrated in FIGS. 1-3, as well as a wide variety of other suitable cable constructions.

Turning now to FIGS. 1-3, a few non-limiting examples of optical fiber cables that include one or more tight buffer units that have at least one conductive wire coupled to a tight buffer layer are illustrated. A wide variety of different types of cables may be constructed utilizing one or more tight buffered units. These cables may include, for example, optical fiber cables, telecommunications cables, and/or a wide variety of composite cables (e.g., cables including a combination of optical fiber(s) and other transmission media). Additionally, embodiments of the disclosure may be utilized in association with drop cables, horizontal cables, vertical cables, flexible cables, plenum cables, riser cables, or any other appropriate cables.

FIG. 1 illustrates a first example cable 100 that may incorporate a tight buffer unit having a toner wire coupled to a tight buffer layer, according to an illustrate embodiment of the disclosure. The cable 100 is illustrated as a simplex or single fiber drop cable. However, other drop cable designs may include any suitable number of tight buffered optical fibers and/or tight buffer units. With reference to FIG. 1, the cable 100 may include a tight buffer unit 105 (“TBU”) and an outer jacket 110 formed around the TBU 105. For example, the TBU 105 may be positioned within a core defined by the outer jacket 110. In certain embodiments, the cable 100 may include one or more additional layers and/or components positioned between the TBU 105 and the outer jacket 110, such as a water blocking layer 115 and/or a strength layer (e.g., a layer of strength yarns, etc.).

As set forth above, the TBU 105 may include an optical fiber, a tight buffer layer formed around the optical fiber, and a conductive toner wire coupled to the tight buffer layer. A few non-limiting examples of tight buffer units that may be incorporated into the cable 100 of FIG. 1 and/or into a wide variety of other suitable cable designs are discussed in greater detail below with reference to FIGS. 4A-4E. Although FIG. 1 illustrates a single TBU 105 positioned within the outer jacket 110, in other embodiments, a plurality of TBUs may be positioned with the outer jacket 110. In yet other embodiments, the cable 100 may include an optical fiber subunit positioned within the outer jacket 110. The fiber subunit may include any number of TBUs, such as one, two, three, or any other suitable number of TBUs. In certain embodiments, the fiber subunit may include a suitable sheath layer (or sheath) formed around one or a plurality of TBUs. As desired, a ripcord may be positioned within the sheath.

The outer jacket 110 may enclose the internal components of the cable 100, seal the cable 100 from the environment, and provide strength and structural support. The jacket 110 may include any number of layers (e.g., a single layer, multiple layers, etc.) and may be formed from a wide variety of suitable materials, such as one or more polymeric materials, polyvinyl chloride (“PVC”), polyurethane, a fluoropolymer, polyethylene, neoprene, cholorosulphonated polyethylene, polypropylene, modified ethylene-chlorotrifluoroethylene, ethylene-vinyl acetate (“EVA”), fluorinated ethylene propylene (“FEP”), ultraviolet resistant PVC, flame retardant PVC, low temperature oil resistant PVC, polyolefin, flame retardant polyurethane, flexible PVC, low smoke zero halogen (“LSZH”) material, plastic, rubber, acrylic, or some other appropriate material known in the art, or a combination of suitable materials. In certain embodiments, the jacket 110 can include flame retardant and/or smoke suppressant materials. Additionally, the jacket 110 may include a wide variety of suitable shapes and/or dimensions. For example, as shown in FIG. 1, the jacket 110 may be formed to result in a round cable or a cable having an approximately circular cross-section. In other embodiments, the jacket 110 may be formed to result in other desired shapes, such as an elliptical shape (e.g., a cable having an approximately oval cross-section) or a rectangular shape. The jacket 110 may also have a wide variety of dimensions, such as any suitable or desirable outer diameter and/or any suitable or desirable wall thickness. In various embodiments, the jacket 110 can be characterized as an outer jacket, an outer sheath, a casing, a circumferential cover, or a shell.

The jacket 110 may enclose one or more openings in which other components of the cable 100 are disposed. At least one opening enclosed by the jacket 110 may be referred to as a cable core, and transmission media may be disposed in the cable core. In the cable 100 illustrated in FIG. 1, a TBU 105 may be disposed in the cable core. In certain embodiments, the jacket 105 may be extruded or pultruded over the TBU 105 during construction of the cable 100.

As desired in various embodiments, water swellable material may be incorporated into the cable 100. For example, water blocking gels, water blocking fibers, water blocking tapes, and/or water blocking yarns may be incorporated into the cable 100. As shown in FIG. 1, in certain embodiments, a water blocking tape 115 may be positioned within the cable core between the TBU 105 and the outer jacket 110. In certain embodiments, the cable 100 may be formed as a dry cable. The term “dry,” as used herein in the context of characterizing a fiber optic cable generally indicates that the cable does not contain any fluids, greases, or gels for blocking water incursion. As a result, it may be easier for a technician to install the cable as the technician will not be required to wipe off a grease or gel when the internal contents of the fiber subunit are accessed. In other embodiments, a water blocking gel or other fluid may be incorporated into the cable 100. For example, a cable core and/or fiber subunit may be filled or partially filled with a suitable filling compound, such as a gelatinous, solid, powder, moisture absorbing material, water-swellable substance, dry filling compound, or foam material.

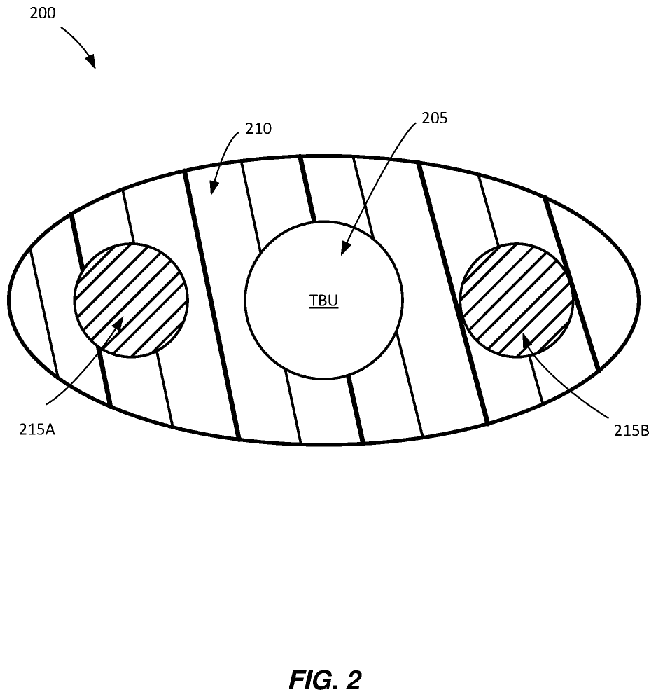

As desired in various embodiments, a wide variety of other materials may be incorporated into the cable 100. For example, one or more strength rods and/or strength layers may be incorporated into the cable 100. In certain embodiments, a layer of strength yarns, such as aramid yarns, basalt fibers, or other suitable strength yarns, may be positioned between the TBU 105 and the jacket 110. In other embodiments, as described in greater detail below with reference to FIG. 2, one or more strength rods may be embedded in the jacket 110. As desired in other embodiments, the cable 100 may include an armor layer (e.g., a metal armor layer, a corrugated armor layer, etc.). One or more location elements may also be incorporated into the cable 100 in various embodiments. In certain embodiments, one or more toner wires incorporated into one or more TBUs, such as the illustrated TBU 105, may be utilized as location elements. In other embodiments, a separate metallic wire (e.g., a copper wire) or strip may be embedded into or attached to the jacket 110. A location element may permit the cable 100 to be located, for example, when buried. Additionally, as desired, the cable 100 may include a wide variety of insulating materials, dielectric materials, flame retardants, flame suppressants or extinguishants, and/or other materials.

FIG. 2 illustrates another example cable 200 that may incorporate a tight buffer unit having a toner wire coupled to a tight buffer layer, according to an illustrate embodiment of the disclosure. Similar to the cable 100 of FIG. 1, the cable 200 may include a TBU 205 and an outer jacket 210 formed around the TBU 205. For example, the TBU 205 may be positioned within a core defined by the outer jacket 210. The cable 200 may also include strength rods 215A, 215B positioned on opposite sides of the TBU 205. In certain embodiments, the cable 200 may include one or more additional layers and/or components positioned between the TBU 205 and the outer jacket 210, such as a water blocking layer and/or a strength layer (e.g., a layer of strength yarns, etc.).

Similar to the jacket 110 described above with reference to FIG. 1, the jacket 210 may enclose the internal components of the cable 200, seal the cable 200 from the environment, and provide strength and structural support. The jacket 210, which may include any number of layers (e.g., a single layer, dual layers, etc.) may be formed from a wide variety of suitable materials and/or may include a wide variety of suitable shapes and/or dimensions. As shown in FIG. 2, the jacket 210 may be formed to result in an elliptical cable or a cable having an approximately oval cross-section. In other embodiments, the jacket 210 may be formed such that the cable 200 has flattened top and bottom surfaces with rounded edge portions. In yet other embodiments, the jacket 210 may be formed such that the cable 200 has a rectangular or approximately rectangular shape. Indeed, the jacket 210 may be formed such that the cable 200 may be characterized as a flat drop cable. As desired, the jacket 210 be formed to result in other desired shapes, such as a round shape.

The jacket 210 may enclose one or more openings in which other components of the cable 200 are disposed. At least one opening enclosed by the jacket 210 may be referred to as a cable core, and transmission media may be disposed in the cable core. Any number of suitable transmission media may be incorporated into the cable 200 as desired. In the cable 200 illustrated in FIG. 2, a TBU 205 may be disposed within the core. In other embodiments, a plurality of TBUs or a fiber optic subunit that includes one or more TBUs may be disposed in the cable core. In yet other embodiments, the cable 200 may be formed as a composite cable that includes both TBU(s) and one or more other types of transmission media, such as one or more twisted pairs of conductors, one or more electrical power conductors, and/or one or more coaxial cables. In certain embodiments, the jacket 210 may be extruded or pultruded over the TBU(s) 205 and/or other internal components during construction of the cable 200. As a result, the cable core may be defined by the size of the internal components during cable construction. In other embodiments, the jacket 210 may be extruded or formed over one or more removable elements (e.g., rods, etc.) in order to define at least one cable core into which one or more TBUs and/or a fiber optic subunit can be inserted or positioned.

As desired, one or more access features may be formed into or incorporated into the jacket 210 to facilitate access of the TBU 205 (or fiber subunit). For example, one or more notches may be formed into the jacket 205 that permit a cable technician to tear open the jacket 210 in order to access the cable core. As another example, one or more peelable or tearable strips may be incorporated into the jacket 210. In other embodiments, one or more notches or access features may be incorporated into the jacket 210 that facilitate removal of the strength rods 215A, 215B. In this regard, the strength rods 215A, 215B may be selectively removed from desired portions of the cable 200. For example, in an indoor/outdoor application, the strength rods 215A, 215B may be utilized while the cable 200 is routed in an outdoor environment. The strength rods 215A, 215B may then be stripped or removed when the cable 200 enters a indoor or premise environment.

In other embodiments, the jacket 210 may be formed with multiple layers to facilitate selective removal of the strength rods 215A, 215B. For example, a first (or inner) jacket layer may be extruded or otherwise formed over the TBU 205. A second (or outer) jacket layer may then be extruded or otherwise formed over the first jacket layer and the strength rods 215A, 215B. The second jacket layer may be designed to be at least partially stripped from the inner jacket layer, for example, using a suitable stripping tool. As a result, the outer jacket layer and the strength rods 215A, 215B can be selectively removed from the cable 200. When the outer jacket layer is maintained, the cable 200 may be more suitable for outdoor deployment. When the outer jacket layer is removed or stripped, the cable 200 may be more suitable for indoor deployment. Thus, the outer jacket layer may be selectively removed during installation of the cable and a portion of the cable may be deployed in an outdoor environment while another portion of the cable is deployed in an indoor environment.

In certain embodiments, one or more strength members may be incorporated into the cable 200. For example, one or more strength rods may be embedded in the cable jacket 210. As shown in FIG. 2, strength rods 215A, 215B may be embedded in the cable jacket 210 on opposite sides of the TBU 205. In other embodiments, strength rods may be embedded at other positions within the jacket 210. Other example embodiments may include strength members incorporated into a cable core. Indeed, a wide variety of different cable constructions may incorporate one or more TBUs (and/or fiber subunits) and one or more strength members at various positions. As described in greater detail below with reference to the central strength member (“CSM”) of FIG. 3, a CSM, strength rods 215A, 215B, and/or other suitable strength members may be formed from a wide variety of suitable materials. Additionally, a strength member may have any desired diameter and/or other dimensions as desired in various embodiments.

As desired in various embodiments, water swellable material may be incorporated into the cable 200. For example, water blocking gels, water blocking fibers, water blocking tapes, and/or water blocking yarns may be incorporated into the cable 200. For example, a water blocking tape may be positioned within the cable core between the TBU 205 and the outer jacket 210 in a similar manner as that illustrated in FIG. 1. In certain embodiments, the cable 200 may be formed as a dry cable. In other embodiments, a water blocking gel or other fluid may be incorporated into the cable 200. For example, a cable core and/or fiber subunit may be filled or partially filled with a suitable filling compound, such as a gelatinous, solid, powder, moisture absorbing material, water-swellable substance, dry filling compound, or foam material.

As desired in various embodiments, a wide variety of other materials may be incorporated into the cable 200. For example, a layer of strength yarns, such as aramid yarns, basalt fibers, or other suitable strength yarns, may be positioned between the TBU 205 and the jacket 210. As desired in other embodiments, the cable 200 may include an armor layer (e.g., a metal armor layer, a corrugated armor layer, etc.). One or more location elements may also be incorporated into the cable 200 in various embodiments. Additionally, as desired, the cable 200 may include a wide variety of insulating materials, dielectric materials, flame retardants, flame suppressants or extinguishants, and/or other materials.

FIG. 3 illustrates another example cable 300 that incorporates one or more tight buffer units that include toner wires coupled to tight buffer layers. The cable 300 may include a plurality of TBUs 305A-F positioned around a central strength member (“CSM”) 310. Additionally, an outer jacket 315 may be formed around the TBUs 305A-F, CSM 310 and any other internal components of the cable 300. In certain embodiments, the cable 300 may include one or more additional layers 320 and/or components positioned between the plurality of TBUs 305A-F and the outer jacket 315, such as a water blocking layer and/or a strength layer (e.g., a layer of strength yarns, etc.).

Each of the TBUs 305A-E (generally referred to as TBU 305) may include an optical fiber, a tight buffer layer formed around the optical fiber, and a conductive toner wire coupled to the tight buffer layer. A few non-limiting examples of tight buffer units that may be incorporated into the cable 300 of FIG. 3 and/or into a wide variety of other suitable cable designs are discussed in greater detail below with reference to FIGS. 4A-4E. Although FIG. 1 illustrates six TBUs 305A-E positioned around a CSM 310, any suitable number of TBUs may be utilized as desired in various embodiments. Additionally, FIG. 1 illustrates the TBUs 305A-E being arranged in a single ring or layer around a CSM 310. In other embodiments, a plurality of rings or layers of TBUs may be positioned around a CSM 310.

Additionally, FIG. 3 illustrates a cable 300 in which each tight buffered optical fiber is incorporated into a respective TBU that includes a conductive toner wire. In other embodiments, a first subset or portion of the tight buffered optical fibers may be incorporated into a TBU while a second subset or portion of the tight buffered optical fibers do not include buffer layers that are coupled to toner wires. Additionally, in certain embodiments, one or more other cable components may be substituted for any desired number of TBUs 305A-F incorporated into the cable 300. These other cable components may include, for example, spacers (i.e., spacers that result in the cable 300 having a desired round or other overall shape, etc.), other transmission media, strength members, water swellable materials, etc.

Further, while FIG. 3 illustrates a cable 300 having individual TBUs 305A-F positioned around a CSM 310, in other embodiments, a plurality of optical fiber subunits may be positioned around the CSM 310. Each optical fiber subunit may include any suitable number of TBUs, such as one, two, three, or any other suitable number of TBUs. In certain embodiments, each fiber subunit may include a suitable sheath layer (or sheath) formed around one or a plurality of TBUs. As desired, a ripcord may be positioned within the sheath. Indeed, a wide variety of configurations of optical fiber subunits, TBUs, and/or other suitable components may be incorporated into a cable 300 and positioned around a CSM 310.

Similar to the jacket 310 described above with reference to FIG. 1, the jacket 315 may enclose the internal components of the cable 300, seal the cable 300 from the environment, and provide strength and structural support. The jacket 315, which may include any number of layers (e.g., a single layer, dual layers, etc.) may be formed from a wide variety of suitable materials and/or may include a wide variety of suitable shapes and/or dimensions. The jacket 315 may also be formed with any suitable cross-sectional shape, such as a round cross-sectional shape. The jacket 315 may enclose one or more openings in which other components of the cable 300 are disposed. At least one opening enclosed by the jacket 315 may be referred to as a cable core, and transmission media and/or other components may be disposed in the cable core. Any number of suitable transmission media may be incorporated into the cable 300 as desired. In the cable 300 illustrated in FIG. 3, a plurality of TBUs 305A-F may be disposed within the core. In other embodiments, any desired number of TBUs, optical fiber subunits, other transmission media, and/or other components may be disposed in the cable core. In certain embodiments, the jacket 315 may be extruded or pultruded over the TBU(s) 305A-F and/or other internal components during construction of the cable 300.

As desired, one or more access features may be formed into or incorporated into the jacket 315 to facilitate access of the TBUs 305A-F. For example, one or more peelable or tearable strips, notches, or points of weakness may be incorporated into the jacket 315. In other embodiments, one or more ripcords may be incorporated into the cable core to facilitate easier stripping of the jacket 315.

In certain embodiments, one or more strength members may be incorporated into the cable 300. For example, one or more strength members, such as central strength member 310, may be disposed or positioned within a cable core. As desired, the TBUs 305A-F (and/or other cable components situated within the cable core) may be stranded around the central strength member 310. For example, the TBUs 305A-F may be helically twisted or S-Z stranded about the central strength member 310. In other embodiments, one or more strength members may be embedded in the cable jacket 315. For example, strength rods may be embedded in the cable jacket 315 on opposite sides of a cable core. In another example embodiment, the cable 300 can be formed with a “figure-8” design that is suitable for aerial deployment, for example, spanning between poles. In such a design, a strength member can be positioned within one loop of the figure-8 and a cable core containing one or more TBUs may be positioned within the other loop. Indeed, a wide variety of different cable constructions may incorporate one or more tight buffered optical fibers and one or more strength members at various positions.

Strength members, such as the central strength member 310, may be formed from a wide variety of suitable materials. For example, strength members may be formed from metal wires (e.g., steel wire, etc.), metal rods, plastic rods, fiber-reinforced plastic (“FRP”) rods, glass-reinforced plastic (“GRP”) rods, fiberglass, or any other suitable material or combination of materials. As desired, a strength member may be formed from a plurality or combination of materials. For example, a strength member may be formed as a central rod (e.g., an FRP rod, etc.) that is coated with one or more additional layers, such as an elastomeric layer (e.g., silicone rubber, etc.) that provides compression cushioning and/or a friction inducing coating that promotes physical bonding and/or thermal coupling between the strength member and the TBUs 305A-F. Additionally, a strength member may have any desired diameter and/or other dimensions as desired in various embodiments. For example, a strength member may be sized based upon a number of TBUs 305A-F and/or other cable components that are stranded with the strength member.

In other embodiments, a CSM 310 may be formed from or may include other types of transmission media. For example, one or more twisted pairs of individually insulated conductors may be utilized as a CSM 310. As another embodiments, one or more power conductors and/or coaxial conductors may be utilized as a CSM 310. In this regard, the cable 300 may be formed as a hybrid or composite cable in which transmission media other than optical fibers are utilized as a CSM 310.

As desired in various embodiments, a wide variety of additional layers 120 may be positioned within the cable core, for example, between the TBUs 305A-E and the outer jacket 315. For example, a water blocking tape or other water blocking layer may be wrapped around the TBUs 305A-F. As another example, a strength layer (e.g., a layer of strength yarns, etc.) may be formed around the TBUs 305A-F. A wide variety of other suitable additional layers and/or components may be utilized as desired in other embodiments.

Similar to the cables 100, 200 of FIGS. 1 and 2, a wide variety of suitable water swellable and/or water blocking materials may be incorporated into the cable 300. For example, water blocking gels, water blocking fibers, water blocking tapes, and/or water blocking yarns may be incorporated into the cable 300. As shown in FIG. 3, in certain embodiments, a water blocking tape may be utilized as an additional layer 320 positioned within the cable core between the TBUs 305A-F and the outer jacket 315. In certain embodiments, the cable 300 may be formed as a dry cable. In other embodiments, a water blocking gel or other fluid may be incorporated into the cable. As desired in various embodiments, a wide variety of other materials may be incorporated into the cable 300. For example, the cable 300 may include an armor layer (e.g., a metal armor layer, a corrugated armor layer, etc.), one or more location elements a wide variety of insulating materials, dielectric materials, flame retardants, flame suppressants or extinguishants, and/or other materials.

The cables 100, 200, 300 illustrated in FIGS. 1-3 are provided by way of example only. Embodiments of the disclosure contemplate a wide variety of other cables and cable constructions. These other cables may include more or less components than the cables 100, 200, 300 illustrated in FIGS. 1-3. Indeed, tight buffer units having toner wires coupled to tight buffer layers may be incorporated into a wide variety of different types of cables.

Regardless of its overall construction, at least one tight buffer unit that includes a toner wire coupled to a tight buffer layer may be incorporated into a cable. Additionally, a TBU may be formed with a wide variety of suitable constructions. A few non-limiting examples of TBUs are illustrated in FIGS. 4A-F and described in greater detail below. Any of these example TBUs, as well as a wide variety of other suitable TBU constructions, may be incorporated into a wide variety of suitable cable designs, such as any of the cables 100, 200, 300 of FIGS. 1-3.

Turning now to FIG. 4A, a first example TBU 400 that includes a conductive toner wire coupled to a tight buffer layer is illustrated. As shown, the TBU 400 may include an optical fiber 402, a tight buffer layer 404 formed around the optical fiber 402, and a conductive toner wire 406 in contact with and coupled to the tight buffer layer 404. Each of these components is described in greater detail below.

The optical fiber 402 may include at least one optical fiber with a core and a cladding. In certain embodiments, one or more protective coatings or protective layers may be formed on the cladding. A tight buffer layer 404 may then be formed on the protective coating(s) or, in embodiments with no protective coating formed on the cladding, directly on the cladding. As desired, the combination of the core and the cladding may be referred to as an optical fiber or an optical wave guide. Additionally or alternatively, the tight buffered optical fiber, including the optical wave guide, one or more optional protective coatings, and a buffer layer, may be generally referred to as an optical fiber.

In certain embodiments, the optical fiber 402 may include a single core. In other embodiments, the optical fiber 402 may include multiple cores. The core may be configured to propagate light at one or more desirable wavelengths (e.g., 1310 nm, 1550 nm, etc.) and/or at any desired transmission rate or data rate, such as a transmission rate between approximately 10 Giga bits per second (“Gbps”) and approximately 40 Gbps. The cladding may have a lower index of refraction than that of the core, to facilitate propagation of a signal through the core. The core and the cladding may include any suitable compositions and may be formed from a wide variety of suitable materials, such as glass, glassy substance(s), one or more silica materials, one or more plastic materials, or a suitable combination of materials.

A wide variety of different types of optical fibers may be utilized as desired in various embodiments. For example, an optical fiber may be a single mode fiber, multi-mode fiber, or some other suitable optical waveguide that carries data. The optical fiber may also have any suitable cross-sectional diameter or thickness. For example, a single mode fiber may have a core diameter between approximately 8 micrometers and approximately 10.5 micrometers with a cladding diameter of approximately 125 micrometers. As another example, a multi-mode fiber may have a core diameter of approximately 50 micrometers or 62.5 micrometers with a cladding diameter of 125 micrometers. Other sizes of fibers may be utilized as desired.

In certain embodiments, one or more protective coatings may be formed on or around the cladding of the optical fiber 402. The protective coating(s) may protect the optical fiber from physical, mechanical, and/or environmental damage. For example, the protective coating(s) may protect against mechanical stresses, scratches, and/or moisture damage. In the event that multiple protective coatings are utilized, the coatings may be applied in concentric layers. In certain embodiments, a dual-layer protective coating approach may be utilized. An inner primary coating may be formed around the cladding, and an outer secondary coating may be formed around the inner coating. The outer secondary coating may be harder than the inner primary coating. In this regard, the inner primary coating may function as a shock absorber to minimize attenuation caused by microbending, and the outer secondary coating may protect against mechanical damage and act as a barrier to lateral forces. Other configurations of protective coating(s) may be utilized as desired in various embodiments. Additionally, the protective coating(s) may be formed from a wide variety of suitable materials and/or combinations of materials. A few example materials include, but are not limited to acrylates, acrylate resins, ultraviolet (“UV”)-cured materials, urethane acrylate composite materials, etc.

A tight buffer layer or buffer layer 404 may be formed around the optical fiber 402 and, if present, the protective coating(s). According to an aspect of the disclosure, the buffer layer 404 may be formed in intimate contact with an underlying layer along a longitudinal length of the optical fiber 402. In other words, the buffer layer 404 may encapsulate the underlying optical fiber 402 and protective coating(s) at any given cross-section of the optical fiber 402 taken along a longitudinal direction. The formation of a buffer layer 404 in intimate contact with an underlying layer (i.e., approximately no spacing between the buffer layer 404 and an underlying layer) may be referred to as a tight buffered configuration. Thus, the combination of the optical fiber 402 and the buffer layer 404 may be referred to as a tight buffered optical fiber. In a typical tight buffered configuration, a buffer layer 404 will be in intimate contact with an underlying optical fiber 402 along an entire outer surface of the optical fiber 402. In other embodiments, a buffer layer 404 may be formed to be in intimate contact with only a portion of an outer surface of the optical fiber 402. For example, relatively small channels or other spaces may be positioned in the buffer layer 404 at desired locations along an outer periphery and/or outer surface of the optical fiber 402 in order to reduce buffer material and/or facilitate easier stripping of the buffer layer 404. Regardless of whether a buffer layer 404 is in intimate contact with an entire outer surface or only a portion of the outer surface of an optical fiber 402 (or protective coating or intermediate layer), the buffer layer 404 may still be characterized as a tight buffer layer.

In certain embodiments, the buffer layer 404 may be formed directly on an outer layer of the optical fiber 402 (i.e., an outer protective layer, the cladding, etc.). In other embodiments, one or more intermediate layers may be positioned between the buffer layer 404 and the optical fiber 402. For example, a suitable release layer may be positioned between the optical fiber 402 and the buffer layer 404 in order to facilitate easier stripping of the buffer layer 404 from the optical fiber 402. In other embodiments, one or more substances or materials (e.g., water blocking powder, water blocking gel, etc.) may be applied to an outer surface of the optical fiber 402 prior to formation of the buffer layer 404.

A wide variety of suitable materials and/or combinations of materials may be utilized to form the buffer layer 404. For example, the buffer layer 404 may be formed from one or more suitable polymeric materials and/or thermoplastic materials. Examples of suitable materials include, but are not limited to polypropylene (“PP”), polyvinyl chloride (“PVC”), a low smoke zero halogen (“LSZH”) material, polyethylene (“PE”), nylon, polybutylene terephthalate (“PBT”), polyvinylidene fluoride (“PVDF”), fluorinated ethylene propylene (“FEP”), etc. In various embodiments, a polymeric material may include a single material component or a mixture of various components. Additionally, in certain embodiments, the buffer layer 404 may be formed as a single layer. In other embodiments, the buffer layer 404 may include a plurality of layers, such as a plurality of co-extruded or successively extruded layers. In the event that a plurality of layers are utilized, in certain embodiments, each layer may be formed from the same or from similar materials. In other embodiments, at least two layers may be formed from different materials. In certain embodiments, one or more polymeric and/or thermoplastic material(s) may form a base material of the buffer layer 404, and one or more additives may be combined, mixed, or blended with the base material. For example, one or more slip agents or release agents may be optionally combined with the base material. The slip agents may facilitate relatively easier stripping of the buffer layer 404 from the underlying optical fiber 402. As desired, a slip agent and/or other additives may be combined with a base material with any suitable mix rates or blend rates.

A wide variety of suitable methods and/or techniques may be utilized as desired to form the buffer layer 404 on the optical fiber 402. In certain embodiments, a buffer layer 404 may be extruded onto the optical fiber 402 (and/or around any intermediate layers or other components) via one or more suitable extrusion devices, such as one or more suitable extrusion heads. In one example embodiment, either prior to or during the formation of a cable, an optical fiber 402 may be fed from a suitable source (e.g., a bin, a reel, a box, etc.), and the optical fiber 402 may be fed in relatively close proximity to one or more extrusion devices. The extrusion devices may extrude tight buffer material onto the optical fiber 402 and, as desired, the optical fiber 402 may be passed through one or more dies in order to control an outer diameter of the extruded buffer layer 404.

In certain embodiments, an inner diameter of the buffer layer 404 may be approximately equal to an outer diameter of the optical fiber 402 and/or any intermediate layers. In other words, the buffer layer 404 may be formed in intimate contact with the underlying optical fiber 402 or intermediate layer. The buffer layer 404 may also be formed with any suitable outer diameter. For example, in certain embodiments, the buffer layer 404 may be extruded or otherwise formed to have an outer diameter that is less than approximately 1.0 mm, such as an outer diameter of approximately 900 microns or micrometers. In other embodiments, the buffer layer 404 may be formed to have an outer diameter of approximately 200, 250, 300, 400, 500, 600, 700, 800, 900, or 1000 microns, an outer diameter included in a range between any two of the above values, or an outer diameter included in a range bounded on a maximum end by one of the above values. Other suitable outer diameters may be utilized as desired for the buffer layer 404. Further, the buffer layer 404 may be formed with a wide variety of suitable thicknesses (i.e., a difference between an inner and outer diameter) as desired in various embodiments. In certain example embodiments, the buffer layer 404 may have a thickness between approximately 50 microns and approximately 875 microns.

With continued reference to FIG. 4A, a conductive toner wire 406 may be coupled to the tight buffer layer 404. The toner wire 406 may have a low coefficient of thermal expansion. As a result of being coupled to the tight buffer layer 404, the toner wire 406 may facilitate reduced shrinkage of the tight buffer layer 404, thereby improving cold temperature performance. Similarly, the toner wire 406 may facilitate reduced expansion of the tight buffer layer 404.

The toner wire 406 may be formed from a wide variety of suitable materials and/or combinations of materials. In certain embodiments, the toner wire 406 may include electrically conductive material(s) having a relatively low coefficient of thermal expansion. Examples of suitable electrically conductive materials include, but are not limited to copper, aluminum, silver, annealed copper, gold, and/or other suitable metallic materials, metallic alloys, conductive composite materials, etc. Indeed, suitable electrically conductive materials may include any material having an electrical resistivity of less than approximately 1×10⁻⁷ ohm meters at approximately 20° C., such as an electrical resistivity of less than approximately 3×10⁻⁸ ohm meters at approximately 20° C. Additionally, electrically conductive material incorporated into a toner wire 406 may be formed as either a solid conductor or, alternatively, as a plurality of conductive strands that are twisted together. As a result of utilizing electrically conductive materials, the toner wire 406 may be utilized to transmit a toning or location signal.

In other embodiments, a non-conductive component having a low coefficient of thermal expansion may be substituted for a conductive toner wire. For example, a strength rod or other suitable component may be substituted for a conductive toner wire. Although conductive toner wires are generally described herein, it will be appreciated that non-conductive components may be substituted as desired in various embodiments. Additionally, in certain embodiments, a cable may include a combination of TBUs that incorporate conductive toner wires and non-conductive components. For example, a cable may include a plurality of TBUs. A first portion or subset of the plurality of TBUs may be formed with respective conductive toner wires. A second portion or subset of the plurality of TBUs may include non-conductive components coupled to their respective tight buffer layers.

According to an aspect of the disclosure, a toner wire 406 (or similar non-conductive component) may have a relatively low coefficient of thermal expansion (“CTE”). For example, a toner wire 406 may have a CTE of approximately 0.000080 per 1/° C. or less. In certain embodiments, a toner wire 406 may have a CTE of approximately 0.000001 per 1/° C., 0.000005 per 1/° C., 0.000010 per 1/° C., 0.000020 per 1/° C., 0.000030 per 1/° C., 0.000040 per 1/° C., 0.000050 per 1/° C., 0.000060 per 1/° C., 0.000070 per 1/° C., or 0.000080 per 1/° C., a CTE included in a range between any two of the above values, or a CTE included in a range bounded on a maximum end by one of the above values.

In certain embodiments, the toner wire 406 may be formed without insulation. In other embodiments, the toner wire 406 may include dielectric insulation formed around a conductor or conductive element. Examples of suitable dielectric materials that may be utilized to form insulation include, but are not limited to, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins, a low smoke zero halogen (“LSZH”) material, a low smoke halogen free (“LSHF”) material, etc.), polyurethane, neoprene, cholorosulphonated polyethylene, flame retardant PVC, low temperature oil resistant PVC, flame retardant polyurethane, flexible PVC, nylon, polybutylene terephthalate (“PBT”), polyvinylidene fluoride (“PVDF”), or a combination of any of the above materials. As desired in certain embodiments, insulation may additionally include a wide variety of other materials (e.g., filler materials, materials compounded or mixed with a base insulation material, etc.), such as smoke suppressant materials, flame retardant materials, etc. Additionally, in certain embodiments, the insulation may be formed from the same material(s) as those utilized to form the buffer layer 404.

In various embodiments, toner wire insulation may be formed from one or multiple layers of insulation material. A layer of insulation may be formed as solid insulation, unfoamed insulation, foamed insulation, or other suitable insulation. As desired, a combination of different types of insulation may be utilized. For example, a foamed insulation layer may be covered with a solid foam skin layer. Additionally, the insulation may be formed with any suitable thickness, inner diameter, outer diameter, and/or other dimensions.

In certain embodiments, the toner wire insulation may be formed separately from the buffer layer 404. In other words, a first extrusion process may be utilized to form the buffer layer 404 while a second and separate extrusion process is utilized to form the toner wire insulation. In other embodiments, a single extrusion operation may be utilized to form both the buffer layer 404 and the toner wire insulation. In yet other embodiments, the toner wire insulation and the buffer layer 404 may be co-extruded from the same or different materials.

Regardless of whether the toner wire 406 is formed with or without insulation, the toner wire 406 may be formed with any suitable dimensions. For example, the toner wire 406 (or a conductor incorporated into the toner wire 406) may be formed with any suitable diameter, gauge, cross-sectional area, and/or other dimensions. In certain embodiments, the toner wire 406 may have an outer diameter of approximately 1.0 mm or less. In various example embodiments, the toner wire 406 may have an outer diameter of approximately 200, 250, 300, 400, 500, 600, 700, 800, 900, or 1000 microns, an outer diameter included in a range between any two of the above values, or an outer diameter included in a range bounded on a maximum end by one of the above values. In certain embodiments, the toner wire 406 may have an outer diameter that is approximately equal to that of the buffer layer 404.

The toner wire 406 may also be formed with a wide variety of suitable cross-sectional shapes. In certain embodiments, as shown in FIG. 4A, the toner wire 406 may be formed with a circular cross-sectional shape. Other suitable cross-sectional shapes may be utilized as desired including, but not limited to, elliptical, rectangular, square, hexagonal, octagonal, or other shapes. As desired for certain cross-sectional shapes, one or more corners of a toner wire 406 may be sharp, rounded, smoothed, curved, angled, truncated, or otherwise formed.

Additionally, according to an aspect of the disclosure, the toner wire 406 may be tightly or intimately coupled to the buffer layer 404. Coupling the toner wire 406 to the buffer layer 404 assists in reducing shrinkage and/or elongation of the buffer layer 404 due to temperature and/or environmental fluctuations and/or stresses. For example, coupling the toner wire 406 to the buffer layer 404 may improve the cold temperature performance of the TBU 400 and reduce shrinkage of the buffer layer 404 due to cold temperatures. In certain embodiments, a maximum distance between the optical fiber 402 and the toner wire 406 may be approximately 1.0 mm or less. For example, in various embodiments, a maximum distance between the optical fiber 402 and the toner wire 406 may be approximately 200, 250, 300, 400, 500, 600, 700, 800, 900, or 1000 microns, a distance included in a range between any two of the above values, or a distance included in a range bounded on a maximum end by one of the above values. In certain embodiments, a maximum distance between the optical fiber 402 and the toner wire 406 may be approximately equal to a thickness of a buffer layer 404 formed around the optical fiber 402.

A wide variety of suitable methods and/or techniques may be utilized to couple the toner wire 406 to the tight buffer layer 404. As shown in FIG. 4A, certain techniques may result in the toner wire 406 being positioned in intimate contact with the buffer layer 404 after the buffer layer has been formed. In certain embodiments, the toner wire 406 may be pressed into the polymeric material utilized to form the buffer layer 404, for example, prior to the buffer layer 404 being completely cooled. In other embodiments, the toner wire 406 may be adhered to the buffer layer 404. In other embodiments, the toner wire 406 and the buffer layer 404 may be helically twisted together. FIG. 4D illustrates an example TBU in which an insulated toner wire is positioned in intimate contact with a buffer layer after the buffer layer has been formed. In other embodiments, as explained in greater detail below with reference to FIG. 4B, the toner wire 406 may be positioned into a longitudinally extending groove or channel formed in the buffer layer 404. In other embodiments, as explained in greater detail below with reference to FIG. 4C, polymeric material(s) may be extruded or co-extruded around both the optical fiber 402 and the toner wire 406 to respectively form the buffer layer 404 and toner wire insulation. As desired, the tight buffered optical fiber and the toner wire may be arranged in a figure eight configuration. In yet other embodiments, as explained in greater detail below with reference to FIG. 4E, the toner wire 406 may be formed around the buffer layer 404. A wide variety of other suitable configurations may be utilized as desired in other embodiments.

FIG. 4B illustrates a second example TBU 410 that includes a conductive toner wire coupled to a tight buffer layer. Similar to the TBU 400 of FIG. 4A, the TBU 410 may include an optical fiber 412, a tight buffer layer 414 formed around the optical fiber 412, and a toner wire 418 in contact with and coupled to the buffer layer 414. Each of these components may be similar to those described above with reference to FIG. 4A. However, in contrast to the TBU 400 illustrated in FIG. 4A, the toner wire 418 of FIG. 4B may be positioned within a groove or channel 416 formed along an outer periphery of the buffer layer 414.

In certain embodiments, the groove or channel 416 may be formed as a result of pressing the toner wire 418 into the buffer layer 414 following extrusion of the buffer layer 414 and prior to polymeric material utilized to form the buffer layer 414 being allowed to cool and/or set. In other embodiments, the buffer layer 414 may be formed to include a groove 416, and the toner wire 418 may be subsequently positioned into the groove 416. Additionally, in certain embodiments, the groove 416 may be relatively straight along a longitudinal length of buffer layer 414. In other words, the groove 416 may be parallel to the longitudinal direction in which the buffer layer 414 extends. In other embodiments, the groove 416 may generally extend along a longitudinal direction while at least various sections or portions of the groove 416 are formed at an angle relative to the longitudinal direction. For example, the groove 416 may spiral around an outer periphery of the buffer layer 414.

FIG. 4C illustrates a third example TBU 420 that includes a conductive toner wire coupled to a tight buffer layer. Similar to the TBU 400 of FIG. 4A, the TBU 420 may include an optical fiber 422, a tight buffer layer formed around the optical fiber 422, and a toner wire 424 in contact with and coupled to the buffer layer. Each of these components may be similar to those described above with reference to FIG. 4A. However, in contrast to the TBU 400 illustrated in FIG. 4A, a single extruded layer 426 may function as both the buffer layer and insulation around the toner wire 424. For example, the optical fiber 422 and the toner wire 424 may be positioned in close proximity to one another and the single layer 426 may be extruded around the optical fiber 422 and the toner wire 424. In this regard, the optical fiber 422 and the toner wire 424 may be oriented in a figure eight configuration. In other embodiments, the buffer layer and the toner wire insulation may be co-extruded from the same material or from two different materials. For example, an extrusion device may include two separate extrusion heads that are used to simultaneously form the buffer layer and the toner wire insulation. As another example, two separate extrusion devices may be utilized to simultaneously or sequentially form the buffer layer and the toner wire insulation.

FIG. 4D illustrates a fourth example TBU 430 that includes a conductive toner wire coupled to a tight buffer layer. Similar to the TBU 400 of FIG. 4A, the TBU 430 may include an optical fiber 432, a tight buffer layer 434 formed around the optical fiber 432, and a toner wire in contact with and coupled to the buffer layer 434. Each of these components may be similar to those described above with reference to FIG. 4A. However, the toner wire of FIG. 4D is illustrated as included both a conductive element 436 and insulation 438 formed around the conductive element 436. Each of these components is described in greater detail above with reference to FIG. 4A.

FIG. 4E illustrates a fifth example TBU 440 that includes a conductive toner wire coupled to a tight buffer layer. Similar to the TBU 400 of FIG. 4A, the TBU 440 may include an optical fiber 442, a tight buffer layer 444 formed around the optical fiber 442, and a toner wire 446 in contact with and coupled to the buffer layer 444. Each of these components may be similar to those described above with reference to FIG. 4A. However, in FIG. 4E, the toner wire 446 is illustrated as being formed around the buffer layer 444. For example, the toner wire 446 may be formed as a conductive tape that is curled, longitudinally wrapped, helically wrapped, or otherwise formed around the buffer layer 444. The toner wire 446 may be formed with any suitable thickness or cross-sectional area as desired in various embodiments. For example, the toner wire 446 may have a thickness of approximately 100, 200, 250, 300, 400, 500, 600, 700, 800, 900, or 1000 microns, a thickness included in a range between any two of the above values, or a thickness included in a range bounded on a maximum end by one of the above values.

Additionally, in certain embodiments, a sheath layer 448 may be formed around the toner wire 446. The sheath layer 448 may be formed from a wide variety of materials and/or combinations of materials, such as any of the materials discussed herein with reference to toner wire insulation, buffer layers, and/or outer jackets. Additionally, the sheath layer 448 may be formed with any number of suitable layers and/or with a wide variety of suitable thicknesses and/or other dimensions.

In the event that one or more TBU's are incorporated into a fiber subunit, a fiber subunit may be formed with a wide variety of suitable constructions. For example, a fiber subunit may include a sheath or wrap formed or positioned around any suitable number of TBUs and/or other internal components (e.g., a ripcord, water blocking material, etc.). In various embodiments, a fiber subunit may include one, two, four, eight, twelve, or some other number of TBUs.

The TBUs 400, 410, 420, 430, 440 illustrated in FIGS. 4A-4D are provided by way of example only. Embodiments of the disclosure contemplate a wide variety of other TBU constructions. These other TBUs may include more or less components than the TBUs 400, 410, 420, 430, 440 illustrated in FIGS. 4A-4D. These other TBUs may include any suitable types of optical fibers, a wide variety of buffer layer constructions, and any suitable conductive and/or non-conductive components coupled to the buffer layers to limit shrinkage and/or expansion of the buffer layers.

As a result of forming a TBU, such as any of the example TBUs 400, 410, 420, 430, 440 illustrated in FIGS. 4A-4E, with a toner wire coupled to a tight buffer layer, shrinkage and/or expansion of the tight buffer layer based upon temperature and/or environmental variations may be reduced. For example, the low CTE of the toner wire (e.g., a copper toner wire, etc.) reduces shrinkage in the polymeric buffer layer coupled to the toner wire. In certain embodiments, coupling a toner wire to a tight buffer layer may result in a buffer layer having maximum shrinkage of 0.0000015 per 1/° C.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cable comprising:
at least one tight buffer unit, the tight buffer unit comprising:
an optical fiber;
a tight buffer layer formed around the optical fiber; and
a conductive toner wire coupled to the tight buffer layer, wherein the tight buffer layer comprises a groove formed on its outer surface and the toner wire is positioned within the groove, and
wherein a maximum distance between the optical fiber and the toner wire is 1.0 mm;
an outer jacket formed around the at least one tight buffer unit.

2. The cable of claim 1, wherein the toner wire comprises copper.

3. The cable of claim 1, wherein the toner wire has an outer diameter of 1.0 mm or less.

4. The cable of claim 1, wherein the toner wire comprises a conductor and insulation formed around the conductor.

5. (canceled)

6. (canceled)

7. The cable of claim 1, wherein the groove comprises a groove that extends in a longitudinal direction parallel to the optical fiber.

8. (canceled)

9. (canceled)

10. (canceled)

11. A cable comprising:
an optical fiber;
a tight buffer layer formed around the optical fiber; and
a conductive toner wire in contact with and formed around the tight buffer layer at any given cross-sectional location along a longitudinal length of the tight buffer layer, wherein a maximum distance between the optical fiber and the toner wire is 1.0 mm.

12. The cable of claim 11, wherein the conductive toner wire has a thickness that is less than or equal to 1.0 mm.

13. The cable of claim 11, wherein the toner wire comprises copper.

14. The cable of claim 11, wherein the toner wire comprises a conductor and insulation formed around the conductor.

15. (canceled)

16. (canceled)

17. (canceled)

18. (canceled)

19. (canceled)

20. The cable of claim 11, further comprising:
a jacket formed around the tight buffer layer and the toner wire.

21. The cable of claim 1, wherein the at least one tight buffer unit comprises a plurality of tight buffer units, each of the plurality of tight buffer units comprising a respective toner wire positioned within a corresponding groove formed in the outer surface of a corresponding tight buffer layer.

22. The cable of claim 21, further comprising:
a central strength member,
wherein the plurality of tight buffer units are positioned around the central strength member.

23. The cable of claim 22, wherein the plurality of tight buffer units are stranded around the central strength member.

24. A cable comprising:
at least one tight buffer unit, the tight buffer unit comprising:
an optical fiber;
a tight buffer layer formed around the optical fiber; and
a conductive toner wire in contact with and formed around the tight buffer layer at any given cross-sectional location along a longitudinal length of the tight buffer layer, wherein a maximum distance between the optical fiber and the toner wire is 1.0 mm; and
an outer jacket formed around the at least one tight buffer unit.

25. The cable of claim 11, wherein the conductive toner wire has a thickness that is less than or equal to 1.0 mm.

26. The cable of claim 11, wherein the toner wire comprises copper.

27. The cable of claim 11, wherein the toner wire comprises a conductor and insulation formed around the conductor.

28. The cable of claim 11, wherein the at least one tight buffer unit comprises a plurality of tight buffer units, each of the plurality of tight buffer units comprising a respective toner wire in contact with and formed around a corresponding tight buffer layer.

29. The cable of claim 28, further comprising:
a central strength member,
wherein the plurality of tight buffer units are positioned around the central strength member.

30. The cable of claim 29, wherein the plurality of tight buffer units are stranded around the central strength member.
